(19) United States
(12) Patent Application Publication
(10) Pub. No.: US 2009/0087599 A1
(43) Pub. Date: Apr. 2, 2009

(54) Hollow Composite Article and Method for Making the Same

(75) Inventors: Honda Cheng, Yuanli Township (TW); Wu Ming Jhe, Yuchih Township (TW)

Correspondence Address: PEACOCK MYERS, P.C., 201 THIRD STREET, N.W., SUITE 1340, ALBUQUERQUE, NM, 87102, US

(73) Assignee: Giant Manufacturing Company, Ltd., Taichung Hsien (TW)

(21) Appl. No.: 12/234,886

(22) Filed: Sep. 22, 2008

(30) Foreign Application Priority Data
Sep. 28, 2007 (TW) 096136200

(51) Int. Cl. B29D 22/00; B29C 31/04

(52) U.S. Cl. 428/34.1; 264/219

(57) ABSTRACT

A method for making a hollow composite article includes: preparing a deformable shell; filling the deformable shell with an incompressible-and-flowable material through an access opening in the deformable shell so as to enable a size and a shape of the deformable shell to correspond to those of the hollow composite article in subsequent thermal molding; covering the deformable shell with a composite material; thermally molding the composite material in a mold so as to form the hollow composite article; removing an assembly of the hollow composite article, the deformable shell, and the incompressible-and-flowable material from the mold; opening the access opening and removing the incompressible-and-flowable material from the deformable shell through the access opening; and removing the deformable shell from the hollow composite article.

### CROSS-REFERENCE TO RELATED APPLICATION

This application claims priority of Taiwanese Application No. 096136200, filed on Sep. 28, 2007.

### BACKGROUND OF THE INVENTION

1. Field of the Invention

This invention relates to a hollow composite fiber and a method for making the same, more particularly to a method for making the hollow composite article using a deformable shell filled with an incompressible-and-flowable material during thermal molding of a composite material on the deformable shell.

2. Description of the Related Art

Conventional methods of making a hollow composite article normally involve the use of an inflatable bag or the use of a foam material in a mold during compression molding of a composite material wrapping around the inflatable bag or around the foam material. For the method using the inflatable bag, the inflatable bag expands to a predetermined size and a predetermined shape using pressurized air for compression molding of the composite material. However, when the hollow composite article to be made has an irregular and complicated shape, drawbacks, such as an uneven surface or thickness and an uneven shape, can occur on the hollow composite article thus formed due to unequal expansion in different directions in the inflatable bag. For the method using the foam material, the foam material is difficult to be removed from the hollow composite article thus formed when the latter has a complicated shape, and thus remains in the hollow composite article, which may have an adverse effect on the hollow composite article.

### SUMMARY OF THE INVENTION

Therefore, an object of the present invention is to provide a method for making a hollow composite article that can overcome the aforesaid drawbacks associated with the prior art.

Another object of the present invention is to provide a hollow composite article made by the method of this invention.

According to one aspect of this invention, there is provided a method for making a hollow composite article with a predetermined size and a predetermined shape. The method comprises: (a) preparing a deformable shell defining an inner space and an access opening for access into the inner space, and having a size and a shape corresponding to those of the hollow composite article; (b) filling the inner space in the deformable shell with an incompressible-and-flowable material through the access opening in the deformable shell and closing the access opening in the deformable shell; (c) covering an outer surface of the deformable shell with a composite material; (d) thermally molding the composite material on the deformable shell in a mold so as to form the hollow composite article on the deformable shell; (e) removing an assembly of the hollow composite article, the deformable shell, and the incompressible-and-flowable material from the mold after thermal molding; (f) opening the access opening in the deformable shell and removing the incompressible-and-flowable material from the deformable shell through the access opening in the deformable shell; and (g) removing the deformable shell from the hollow composite article.

According to another aspect of this invention, there is provided a hollow composite article comprising a hollow body of a composite material that includes a main part and a neck reduced in cross-section from the main part.

The hollow body of the composite material is made by a method comprising: (a) preparing a deformable shell defining an inner space and an access opening for access into the inner space, and having a size and a shape corresponding to those of the hollow composite article; (b) filling the inner space in the deformable shell with an incompressible-and-flowable material through the access opening in the deformable shell and closing the access opening in the deformable shell; (c) covering an outer surface of the deformable shell with a composite material; (d) thermally molding the composite material on the deformable shell in a mold so as to form the hollow composite article on the deformable shell; (e) removing an assembly of the hollow composite article, the deformable shell, and the incompressible-and-flowable material from the mold after thermal molding; (f) opening the access opening in the deformable shell and removing the incompressible-and-flowable material from the deformable shell through the access opening in the deformable shell; and (g) removing the deformable shell from the hollow composite article.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a sectional view of a deformable shell used in the preferred embodiment of a method for making a hollow composite article according to this invention;

FIG. 2 is a partly sectional view to illustrate a state of the preferred embodiment where the deformable shell is filled with an incompressible-and-flowable material;

FIG. 3 is a partly sectional view to illustrate a state of the preferred embodiment where the deformable shell is covered with a composite material;

FIG. 4 is a partly sectional view to illustrate a state of the preferred embodiment where an assembly of the deformable shell, the incompressible-and-flowable material, and the composite material is placed in a mold for thermal molding for forming the hollow composite article;

FIG. 5 is a partly sectional view to illustrate a state of the preferred embodiment where the assembly of the deformable shell, the incompressible-and-flowable material, and the composite material is removed from the mold after thermal molding;

FIG. 6 is a partly sectional view to illustrate a state of the preferred embodiment where the incompressible-and-flowable material is removed from the deformable shell;

FIG. 7 is a partly sectional view to illustrate a state of the preferred embodiment where the deformable shell is removed from the hollow composite article; and

FIG. 8 is a sectional view of the hollow composite article formed by the preferred embodiment.

### DETAILED DESCRIPTION OF THE PREFERRED EMBODIMENT

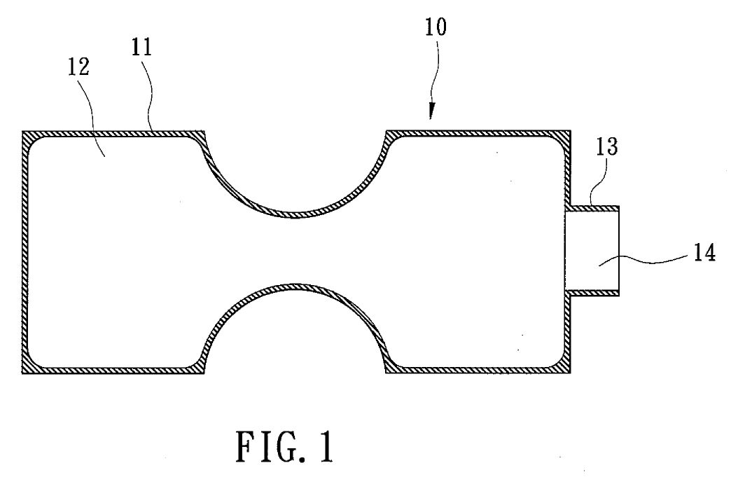

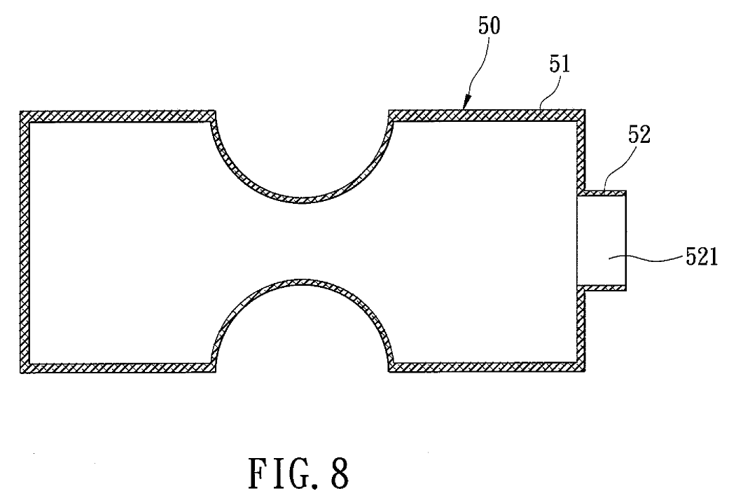

FIGS. 1 to 8 illustrate consecutive steps of the preferred embodiment of a method for making a hollow composite article 50 with a predetermined size and a predetermined shape according to this invention. The hollow composite article 50 has a hollow body including a main part 51 and a neck 52 reduced in cross-section from the main part 51 and defining an outlet 521 (see FIG. 8).

The method includes the steps of:

(a) preparing a deformable shell 10 defining an inner space 12 and an access opening 14 for access into the inner space 12, and having a size and a shape corresponding to those of the hollow composite article 50 (see FIG. 1);

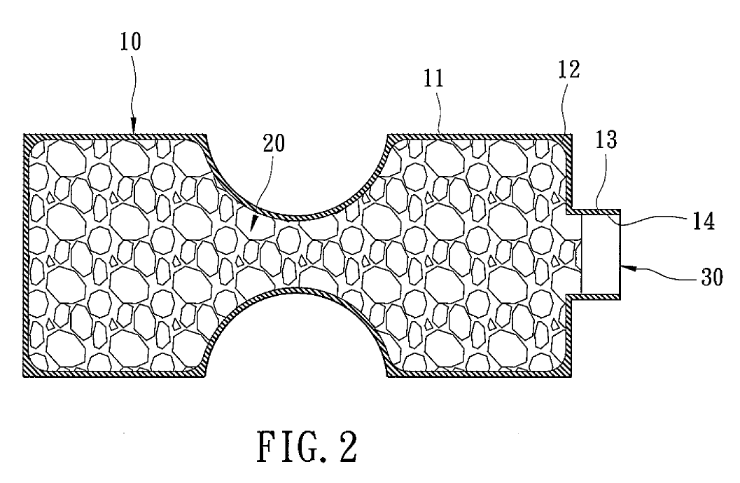

(b) filling the inner space 12 in the deformable shell 10 with an incompressible-and-flowable material 20 through the access opening 14 in the deformable shell 10 and closing the access opening 14 in the deformable shell 10 (see FIG. 2) so as to enable the size and the shape of the deformable shell 10 to correspond to those of the hollow composite article 50 in subsequent thermal molding;

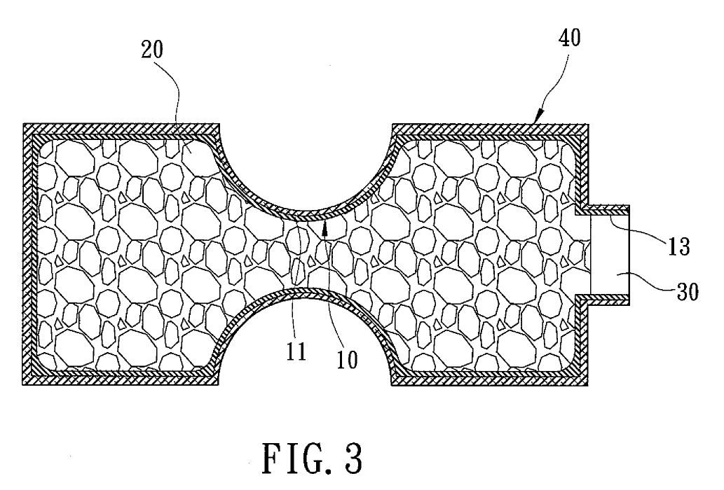

(c) covering an outer surface of the deformable shell 10 with a composite material 40 (see FIG. 3);

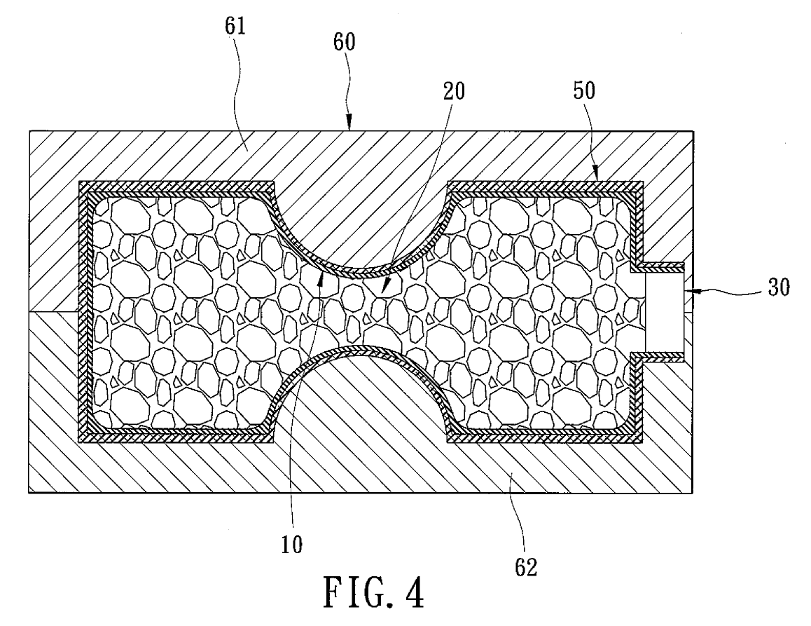

(d) thermally molding the composite material 40 on the deformable shell 10 in a mold 60 so as to form the hollow composite article 50 on the deformable shell 10 (see FIG. 4);

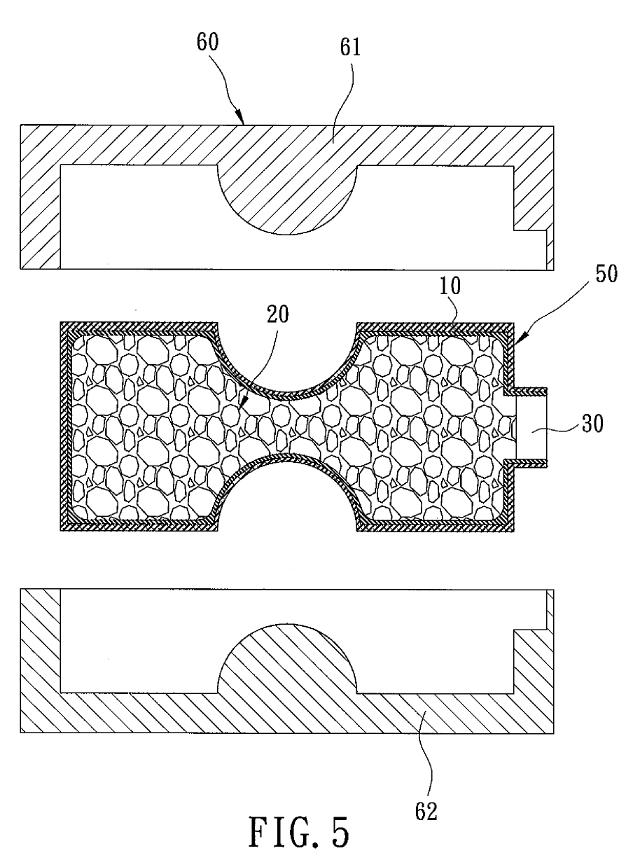

(e) removing an assembly of the hollow composite article 50, the deformable shell 10, and the incompressible-and-flowable material 20 from the mold 60 after thermal molding (see FIG. 5);

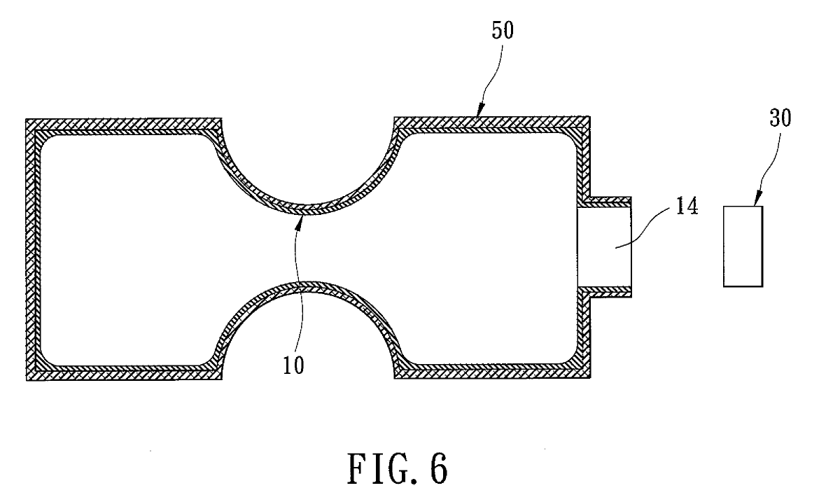

(f) opening the access opening 14 in the deformable shell 10 and removing the incompressible-and-flowable material 20 from the deformable shell 10 through the access opening 14 in the deformable shell 10 (see FIG. 6); and

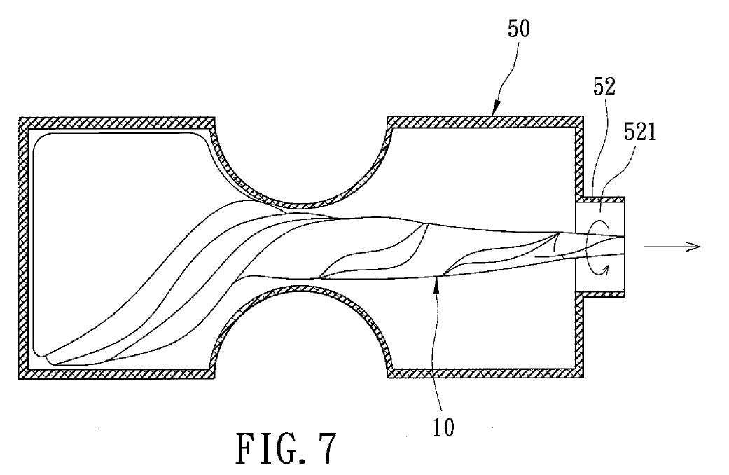

(g) removing the deformable shell 10 from the hollow composite article 50 (see FIG. 7).

In this embodiment, the deformable shell 10 is prepared by plastic blow molding techniques in step (a). The deformable shell 10 thus formed has a main part 11 and a neck 13 reduced in cross-section from the main part 11 and defining the access opening 14 in the deformable shell 10. The closing of the access opening 14 in the deformable shell 10 is conducted by inserting fittingly a plug 30 into the neck 13 (see FIG. 2).

The use of the plug 30 can permit a positive pressure to be built in the inner space 12 in the deformable shell 10 during thermal molding so as to ensure achievement of an even surface and an even shape of the hollow composite article 50. The plug 30 is removed from the neck 13 of the deformable shell 10 through the access opening 14 in the deformable shell 10 for opening the access opening 14 for removal of the incompressible-and-flowable material 20 from the deformable shell 10.

Preferably, the deformable shell 10 is made from a heat-shrinkable material selected from one of polyproplene and nylon. The plug 30 is preferably made from a material selected from one of silicone and iron. The incompressible-and-flowable material 20 is preferably made from a particulate material selected from sand, particulate silicone, and solvent soluble particles. The solvent soluble particles are preferably water soluble particles, such as salts. In one preferred embodiment, the incompressible-and-flowable material 20 is a swellable particulate material, such as a swellable particulate silicone. Suitable examples of the composite material are fiber-reinforced polymers such as carbon fiber reinforced polymers.

In this embodiment, the mold 60 includes two mold halves 61, 62 detachably connected to each other for compression molding of the composite material 40 on the deformable shell 10.

The deformable shell 10 is removed from the hollow composite article 50 through the outlet 521 of the hollow composite article 50 by twisting and pulling the deformable shell 10 outwardly of the latter (see FIG. 7).

With the inclusion of the deformable shell 10 and the incompressible-and-flowable material 20 in the deformable shell 10 for making the hollow composite article 50 of this invention, the aforesaid drawbacks, such as the uneven surface and the uneven shape for the hollow composite article and undesired residual of the foam material in the hollow composite article, associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed:

1. A method for making a hollow composite article with a predetermined size and a predetermined shape, comprising:
(a) preparing a deformable shell defining an inner space and an access opening for access into the inner space, and having a size and a shape corresponding to those of the hollow composite article;
(b) filling the inner space in the deformable shell with an incompressible-and-flowable material through the access opening in the deformable shell and closing the access opening in the deformable shell;
(c) covering an outer surface of the deformable shell with a composite material;
(d) thermally molding the composite material on the deformable shell in a mold so as to form the hollow composite article on the deformable shell;
(e) removing an assembly of the hollow composite article, the deformable shell, and the incompressible-and-flowable material from the mold after thermal molding;
(f) opening the access opening in the deformable shell and removing the incompressible-and-flowable material from the deformable shell through the access opening in the deformable shell; and
(g) removing the deformable shell from the hollow composite article.

2. The method of claim 1, wherein the deformable shell is prepared by plastic blow molding techniques in step (a).

3. The method of claim 1, wherein the deformable shell has a main part and a neck reduced in cross-section from the main part and defining the access opening in the deformable shell, the closing of the access opening in step (b) being conducted by inserting fittingly a plug into the neck.

4. The method of claim 3, wherein the plug is made from a material selected from one of silicone and iron.

5. The method of claim 1, wherein the deformable shell is made from a heat-shrinkable material.

6. The method of claim 5, wherein the heat-shrinkable material is selected from one of polyproplene and nylon.

7. The method of claim 1, wherein the incompressible-and-flowable material is made from a particulate material.

8. The method of claim 7, wherein the particulate material is selected from sand, particulate silicone, and solvent soluble particles.

9. The method of claim 8, wherein the solvent soluble particles are water soluble particles.

10. The method of claim 1, wherein the thermal molding of the composite material is conducted using a mold including two mold halves detachably connected to each other for compression molding of the composite material on the deformable shell.

11. The method of claim 1, wherein the incompressible-and-flowable material is a swellable particulate material.

12. The method of claim 11, wherein the swellable particulate material is a swellable particulate silicone.

13. The method of claim 1, wherein the composite material is made from a fiber-reinforced polymer.

14. A hollow composite article comprising a hollow body of a composite material that includes a main part, and a neck reduced in cross-section from said main part, wherein said hollow body of said composite material is made by a method comprising:
(a) preparing a deformable shell defining an inner space and an access opening for access into said inner space, and having a size and a shape corresponding to those of said hollow composite article;
(b) filling said inner space in said deformable shell with an incompressible-and-flowable material through said access opening in said deformable shell and closing said access opening in said deformable shell;
(c) covering an outer surface of said deformable shell with a composite material;
(d) thermally molding said composite material on said deformable shell in a mold so as to form said hollow composite article on said deformable shell;
(e) removing an assembly of said hollow composite article, said deformable shell, and said incompressible-and-flowable material from said mold after thermal molding;
(f) opening said access opening in said deformable shell and removing said incompressible-and-flowable material from said deformable shell through said access opening in said deformable shell; and
(g) removing said deformable shell from said hollow composite article.
